(19) United States
(12) Patent Application Publication
(10) Pub. No.: US 2018/0098146 A1
(43) Pub. Date: Apr. 5, 2018

(54) NOISE-CANCELLING EARPHONE

(71) Applicant: Merry Electronics(Shenzhen) Co., Ltd., Guangdong (CN)

(72) Inventors: Chia-Chung Lin, Taichung (TW); Chih-Hung Wang, Taichung (TW)

(73) Assignee: Merry Electronics(Shenzhen) Co., Ltd., Guangdong (CN)

(21) Appl. No.: 15/384,240

(22) Filed: Dec. 19, 2016

(30) Foreign Application Priority Data
Sep. 30, 2016 (TW) 105131605

(51) Int. Cl. H04R 1/10

(52) U.S. Cl. CPC H04R 1/1083; H04R 1/1041; H04R 1/1058; H04R 1/1016

(57) ABSTRACT

A noise-cancelling earphone used to provide an audio source to a user's eardrum is provided. The noise-cancelling earphone includes a housing, a speaker, a first microphone and a second microphone. The housing includes a tube and a chamber. The tube has a first end and a second end which is opposite to the first end. The first end of the tube has an audio outlet and the chamber is connected to the second end of the tube. The speaker is disposed inside the housing. The first microphone is disposed on the first end of the tube, and has a first audio inlet facing toward the user's eardrum. The second microphone is disposed inside the chamber, and has a second audio inlet facing toward the external environment.

### CROSS-REFERENCE TO RELATED APPLICATION

This application claims the priority benefit of Taiwan application serial no. 105131605, filed on Sep. 30, 2016. The entirety of the above-mentioned patent application is hereby incorporated by reference herein and made a part of this specification.

### BACKGROUND OF THE INVENTION

### Field of the Invention

The invention is related to an earphone, and particularly related to a noise-cancelling earphone.

### Description of Related Art

With advancement of technologies, the current trends in electronic products are compact and light designs. Compact-sized electronic products such as radios, Walkman or smart phones are used at any time everywhere. No matter what electronic product is used, in order for users to listen to audio information sent from the electronic product without disturbing other people, earphones are made as essential accessories for electronic products.

When earphones are worn on ears, noise is likely to be leaked into ears through the gap between eartip and ear canal and cause disturbance to the user. Current noise-cancelling earphones include active noise-cancelling earphones and passive noise-cancelling earphones. Most passive noise-cancelling earphones adopt the mechanical noise-reducing technique which, however, cannot effectively cancel noise. On the other hand, active noise-cancelling earphones adopt the active noise-cancelling theory to reduce noise by receiving outer noise via microphone and generating a signal having reversed phase relative to the phase of sound wave of noise via electronic circuit to cancel the outer noise that can possibly be heard by the user, thereby achieving the effect of cancelling noise. Generally speaking, the structure of active noise-cancelling earphones is more complicated and takes more time to be assembled. In light of the above, it is an issue to be solved by persons skilled in the art to improve the structure of noise-cancelling earphones.

### SUMMARY OF THE INVENTION

The invention provides a noise-cancelling earphone that can effectively cancel noise and be easily assembled.

In an embodiment of the invention, a noise-cancelling earphone that is used to provide an audio source to a user's eardrum is provided. The noise-cancelling earphone includes a housing, a speaker, a first microphone and a second microphone. The housing includes a tube and a chamber. The tube has a first end and a second end which is opposite to the first end. The first end of the tube has an audio outlet and the chamber is connected to the second end of the tube. The speaker is disposed inside the housing. The first microphone is disposed on the first end of the tube, and has a first audio inlet facing toward the user's eardrum. The second microphone is disposed inside the chamber, and has a second audio inlet facing toward the external environment.

In an embodiment of the invention, the first microphone having a first plane in which the first audio inlet is located and the second microphone having a second plane in which the second audio inlet is located, and the second plane is parallel to the first plane.

In an embodiment of the invention, the first plane of the first microphone is located between the second plane of the second microphone and the audio outlet.

In an embodiment of the invention, the audio outlet is located is located between the first plane of the first microphone and the second plane of the second microphone.

In an embodiment of the invention, the noise-cancelling earphone further includes a carrier, wherein the carrier is connected with the first end of the tube. The carrier has a first accommodating space to accommodate the first microphone, and the first accommodating space is disposed between the tube and the user's eardrum.

In an embodiment of the invention, the speaker is disposed in the chamber of the housing.

In an embodiment of the invention, the noise-cancelling earphone further includes an eartip, wherein the tube is covered by the eartip and the speaker is disposed outside the eartip.

In an embodiment of the invention, the chamber includes a plurality of second accommodating spaces isolated from one another. The speaker and the second microphone are respectively disposed in the second accommodating spaces isolated from one another.

In an embodiment of the invention, the speaker is disposed in the tube of the housing.

In an embodiment of the invention, the noise-cancelling earphone further includes an eartip, wherein the tube is covered by the eartip, and the speaker is disposed in the eartip.

In an embodiment of the invention, the chamber includes a second accommodating space that is isolated from the tube, and the second microphone is disposed in the second accommodating space.

In an embodiment of the invention, the noise-cancelling earphone further includes a partitioning mesh which is disposed at the audio outlet and the first microphone is disposed on the partitioning mesh.

In an embodiment of the invention, a gap is formed at the audio outlet of the housing and surrounds the circumference of the first microphone to allow sound airflow to pass through.

In an embodiment of the invention, the noise-cancelling earphone further includes a circuit carrier and a flexible circuit board. The circuit carrier is disposed in the tube to carry the first microphone. The flexible circuit board is electrically connected with the first microphone, circuit carrier and speaker.

In an embodiment of the invention, the speaker is disposed between the second microphone and the tube.

Based on the above, in the noise-cancelling earphone of the invention, the first audio inlet of the first microphone faces toward the user's eardrum to receive noise in the ear canal; the second audio inlet of the second microphone faces toward the outer environment to receive noise from the outer environment. With such configuration, noise can be collected more efficiently to achieve better noise-cancelling effect.

In order to make the aforementioned features and advantages of the invention more comprehensible, embodiments accompanying figures are described in detail below.

### BRIEF DESCRIPTION OF THE DRAWINGS

FIG. 1 is a schematic view illustrating a noise-cancelling earphone according to a first embodiment of the invention.

FIG. 2 is a schematic view illustrating a noise-cancelling earphone according to a second embodiment of the invention.

FIGS. 3A-3F are schematic views illustrating steps of assembling circuits of the noise-cancelling earphone according to the second embodiment of the invention.

FIG. 4 is a schematic view illustrating a noise-cancelling earphone according to a third embodiment of the invention.

FIG. 5 is a schematic view illustrating a noise-cancelling earphone according to a fourth embodiment of the invention.

### DESCRIPTION OF EMBODIMENTS

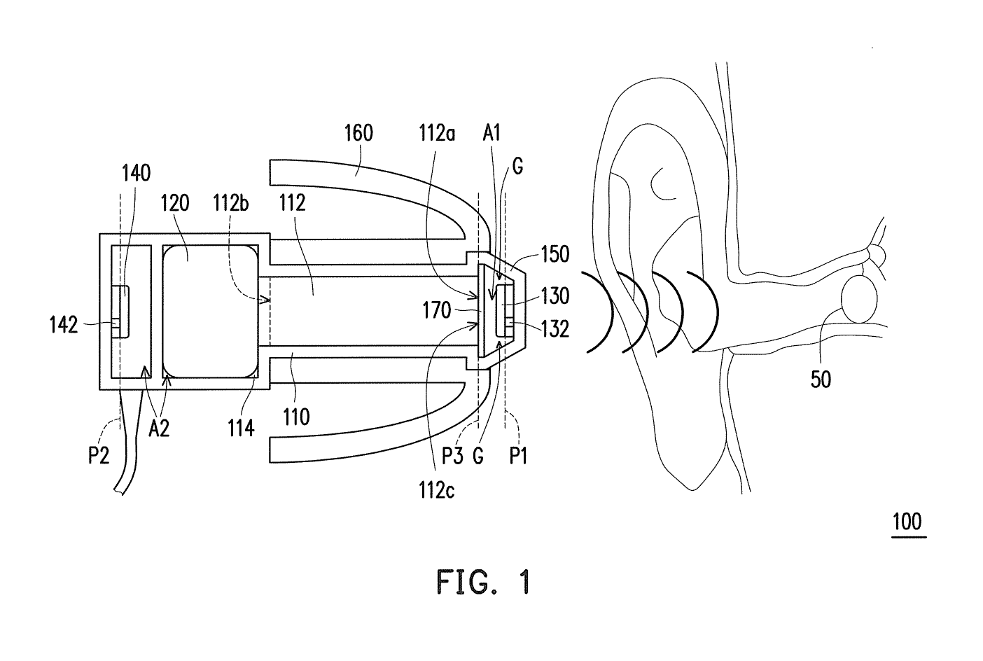

FIG. 1 is a schematic view illustrating a noise-cancelling earphone according to a first embodiment of the invention. Referring to FIG. 1, a noise-cancelling earphone 100 of the embodiment includes a housing 110, a speaker 120, a first microphone 130 and a second microphone 140. The housing 110 includes a tube 112 and a chamber 114. The housing 110 can be, for example, formed in an integrated manner or constituted by a plurality of components, which should not be construed as a limitation to the invention. The tube 112 includes a first end 112a and a second end 112b which is opposite to the first end 112a. The first end 112a of the tube 112 includes an audio outlet 112c, and the chamber 114 is connected with the second end 112b of the tube 112. The speaker 120 is disposed in the housing 110. Specifically, the speaker 120 is disposed in the chamber 114 and between the second microphone 140 and the tube 112.

In the embodiment, the first microphone 130 is disposed on the first end 112a of the tube 112. The first microphone 130 includes a first audio inlet 132 facing toward a user's eardrum 50. The second microphone 140 is disposed in the chamber 114. The second microphone 140 includes a second audio inlet 142 facing toward the external environment. Specifically, the first microphone 130 includes a first plane P1 in which the first audio inlet 132 is located and the second microphone 140 includes a second plane P2 in which the second audio inlet 142 is located, and the second plane P2 is parallel to the first plane P1 and/or a third plane P3 on which the audio outlet 112c is located. In addition, the audio outlet 112c (i.e. the third plane P3) is located between the first plane P1 of the first microphone 130 and the second plane P2 of the second microphone 140. For example, the first microphone 130 can be a feedback microphone, and the second microphone 140 can be a feedfoward microphone.

It should be mentioned that, in the embodiment, the noise-cancelling earphone 100 may further include a carrier 150 and an eartip 160. The carrier 150 is connected with the first end 112a of the tube 112. The carrier 150 includes a first accommodating space A1 to accommodate the first microphone 130, and the first accommodating space A1 is located between the tube 112 and the user's eardrum 50. Certainly, the carrier 150 in FIG. 1 is illustrated for exemplary purpose only, and it should not be construed as a limitation to the invention. Meanwhile, the tube 112 is covered by the eartip 160, and the speaker 120 is disposed outside the eartip 160. In addition, in the noise-cancelling earphone 100, the first microphone 130 and the first audio inlet 132 as well as the second microphone 140 and the second audio inlet 142 are disposed outside the eartip 160. In the embodiment of the invention, the housing 110 can be completely covered by the eartip 160 depending on actual requirements of products, which should not be construed as a limitation to the invention. The material of the eartip 160 can be, for example, soft rubber, plastic or sponge that can be properly deformed according to the shape of user's ear canal, such that the eartip 160 can fit the user's ear canal and block ambient noise, thereby achieving passive noise-cancelling effect and improving fidelity of sound.

Moreover, in the embodiment, the chamber 114 of the noise-cancelling earphone 100 includes a plurality of second accommodating spaces A2 isolated from one another. The speaker 120 and the second microphone 140 are respectively disposed in the second accommodating space A2 isolated from one another. In addition, the second accommodating space A2 where the speaker 120 is disposed communicates with the tube 112.

Specifically, a gap G is formed at the audio outlet 112c of the housing 110 and surrounds the circumference of the first microphone 130 to allow the sound airflow to pass through. Since the installation position of the first microphone 130 of the noise-cancelling earphone 100 is close to the user's eardrum 50, the noise that is leaked into the ear canal can be directly and quickly detected and received by the first microphone 130, thereby generating and outputting a sound wave having reversed phase relative to the phase of noise so as to cancel the noise in the ear canal. Moreover, the second microphone 140 includes the second audio inlet 142 facing toward the outer environment to receive noise from the outside, and generates a signal having reversed phase relative to the phase of sound wave of noise. When the inverted signal (i.e. the signal having reversed phase) is generated, its destructive interference eliminates the outer noise that can possibly be heard by the user, reducing the interference of outer sound caused to the signal output by the earphone. Accordingly, with the configuration of the first microphone 130 and the second microphone 140, the embodiments of the invention can effectively improve the noise-cancelling effect of the noise-cancelling earphone 100.

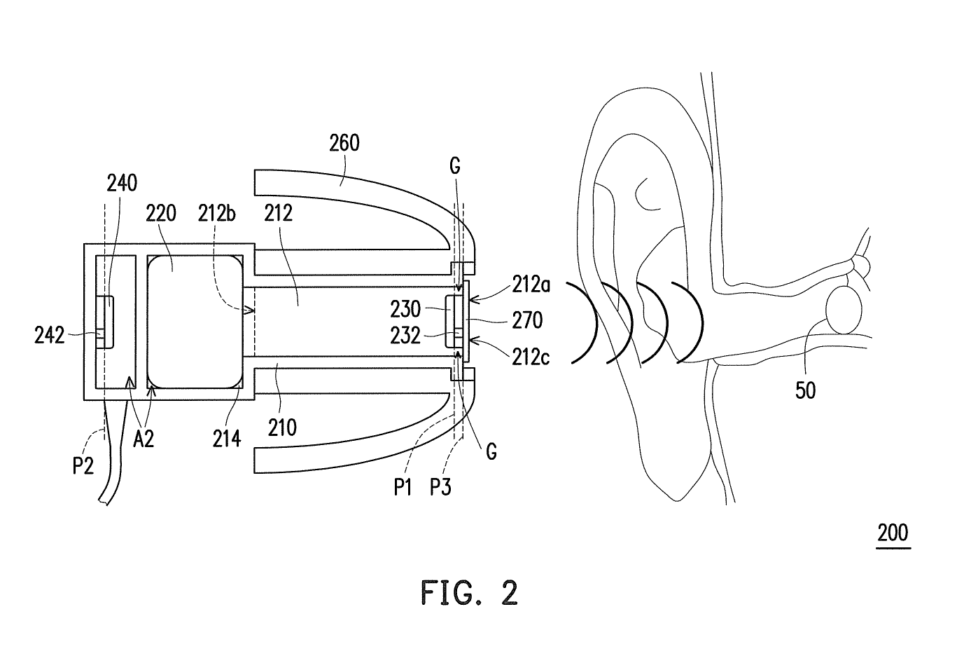

FIG. 2 is a schematic view illustrating a noise-cancelling earphone according to a second embodiment of the invention. Referring to FIGS. 1-2, identical or similar numbers refer to identical or similar elements throughout the drawings, and no repetition will be incorporated in the descriptions. In the embodiment, a noise-cancelling earphone 200 is similar to the noise-cancelling earphone 100 in FIG. 1. The main difference between FIG. 1 and FIG. 2 lies in that the first plane P1 of first microphone 230 is located between the second plane P2 of a second microphone 240 and an audio outlet 212c (i.e. the third plane P3). More specifically, in the noise-cancelling earphone 200, the first microphone 230 and a first audio inlet 232 are disposed in an eartip 260. In other words, the first microphone 230 is disposed to be the most close to a position where the noise is leaked in when the noise-cancelling earphone 200 is worn on the user's ear. With such configuration, the time of collecting the noise transmitted from the ear canal to the first microphone 230 can be shortened. Accordingly, the first microphone 230 can perform noise cancellation more quickly, thereby enhancing the noise-cancelling effect.

Meanwhile, in the embodiment, the noise-cancelling earphone 200 may further include a partitioning mesh 270 which is disposed at the audio outlet 212c to prevent foreign matter from entering the housing 210. The first microphone 230 is disposed on the partitioning mesh 270, for example. Moreover, the first audio inlet 232 of the noise-cancelling earphone 200 is disposed right opposite to the audio outlet 212c; that is, the first audio inlet 232 of the first microphone 230 can be seen from the audio outlet 212c such that a better audio collecting effect can be achieved. In the embodiment, the structure and specific implementation of the noise-cancelling earphone 200 are sufficiently taught, proposed and described in the descriptions in the embodiment of FIG. 1, and thus no further description is incorporated herein.

In other embodiments of the invention, the gap G of the noise-cancelling earphone 200 can also be adaptively adjusted, for example by expanding the gap G that surrounds the first microphone 230 to reduce high frequency loss of speaker.

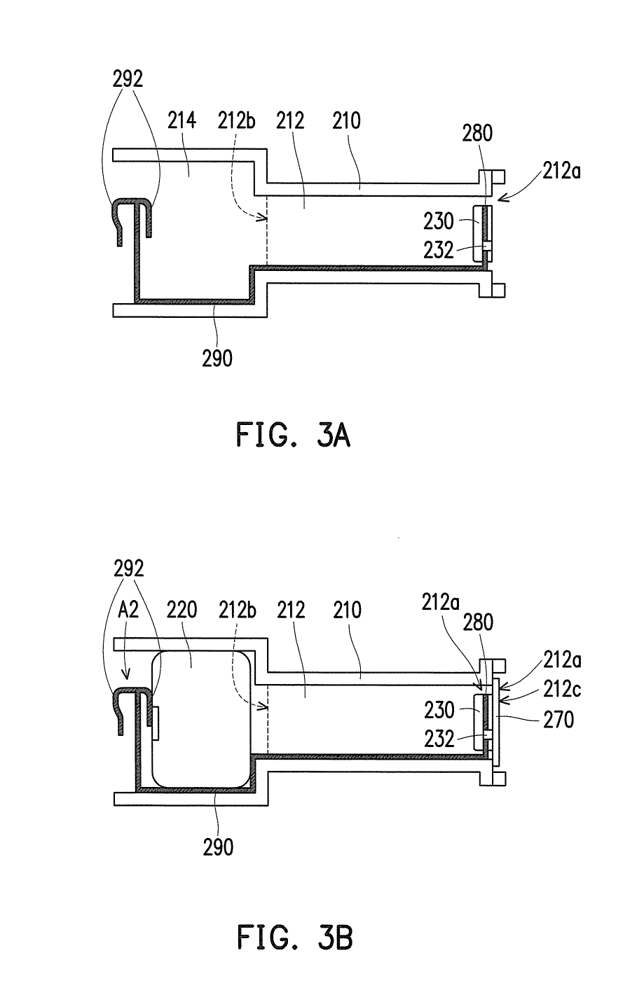

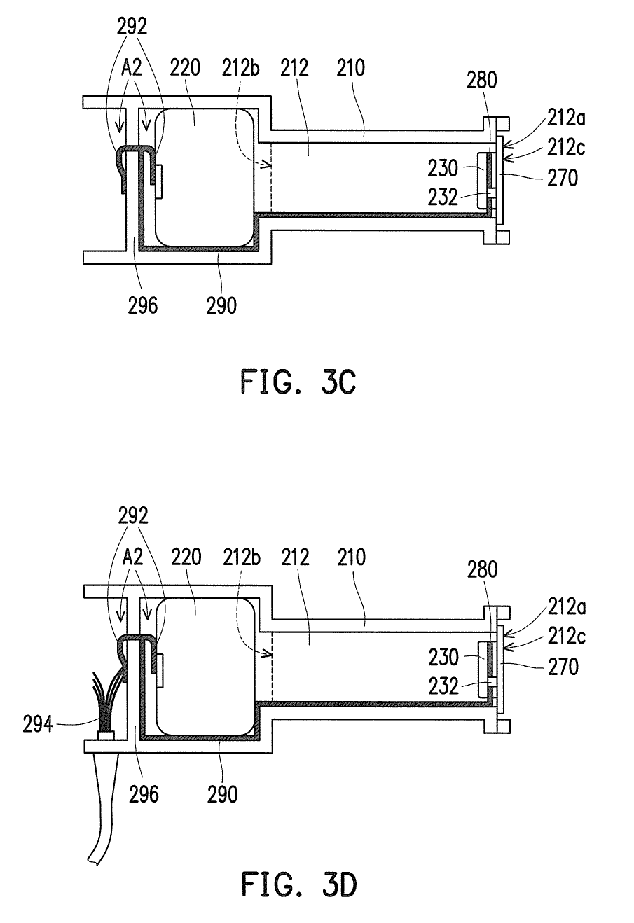

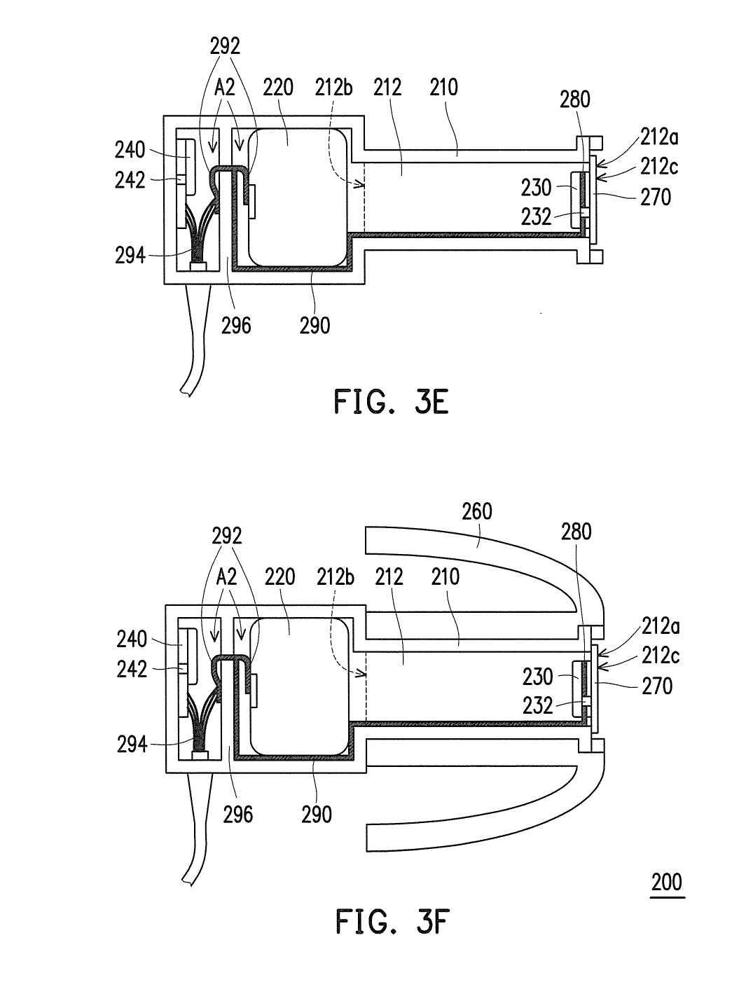

FIGS. 3A-3F are schematic views illustrating steps of assembling the noise-cancelling earphone according to the second embodiment of the invention. Referring to FIG. 2 and FIGS. 3A to 3F, in the embodiment, the noise-cancelling earphone 200 may further include a circuit carrier 280 and a flexible circuit board 290. The circuit carrier 280 is disposed in the tube 212 to carry the first microphone 230. The flexible circuit board 290 is electrically connected with the first microphone 230, circuit carrier 280 and the speaker 220. In addition, the flexible circuit board 290 further includes a pin 292, wherein the pin 292 is electrically connected with the speaker 220 and a signal line 294 respectively. Since a noise-cancelling circuit is in or on the circuit carrier 280 and the flexible circuit board 290, an inverted noise-cancelling signal (i.e. the signal having reversed phase) can be generated via the circuit carrier 280 and a flexible circuit board 290 in accordance with the noise signal collected by the first microphone 230 and second microphone 240. The speaker 220 emits a sound wave that has a reversed phase and identical amplitude relative to the noise so as to destructively interfere with the noise in the ear canal and from outer environment, thereby achieving the noise-cancelling effect.

For example, when assembling the noise-cancelling earphone 200, firstly, the circuit carrier 280 that carries the first microphone 230 and the flexible circuit board 290 electrically connected thereto are disposed in the housing 210, wherein the plane on which the circuit carrier 280 is located is parallel with the plane on which the first microphone 230 is located. The flexible circuit board 290 is disposed along the wall of tube 212 and the edge of chamber 214. In the meantime, the first microphone 230 is disposed on the first end 212a of the tube 212, and the first audio inlet 232 faces toward the audio outlet 212c. Next, the speaker 220 is disposed in a second accommodating space A2 of the chamber 214 such that the speaker 220 is electrically connected with the pin 292; the partitioning mesh 270 is disposed at the audio outlet 212c. Then, a partitioning part 296 that divides the second accommodating space A2 is connected with the housing 210 such that the chamber 214 is formed into two second accommodating spaces A2 that are isolated from each other.

Thereafter, the signal line 294 is disposed into another second accommodating space A2 that is isolated from the one in which the speaker 220 is disposed, and is electrically connected with another pin 292. Afterwards, the second microphone 240 is disposed into another second accommodating space A2 that is isolated from the one in which the speaker 220 is disposed, and is electrically connected with the signal line 294; also, the second audio inlet 242 faces toward the outer environment. The tube 212 is covered by the eartip 260, thereby substantially completing assembling of the noise-cancelling earphone 200. Since the circuit carrier 280 is combined with the flexible circuit board 290 which serves as a rigid-flex circuit board with flexibility of a flexible circuit board and rigidity of a rigid circuit board, under the condition that the inner space of electrical product is significantly reduced, the rigid-flex circuit board allows maximum flexibility for component connection and assembling space as well as simplifies complexity of assembling noise-cancelling earphone.

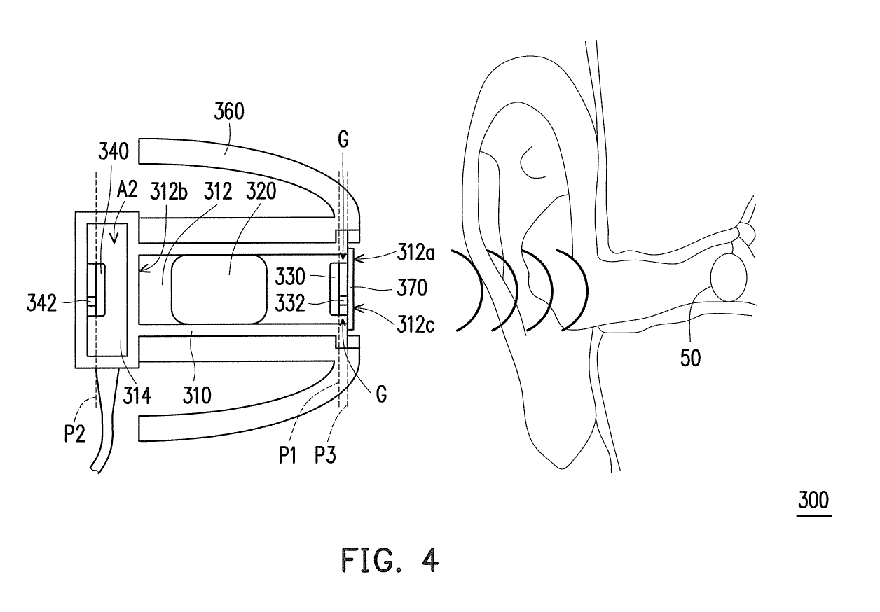

FIG. 4 is a schematic view illustrating a noise-cancelling earphone according to a third embodiment of the invention. Referring to FIGS. 1, 2 and 4, identical or similar numbers refer to identical or similar elements throughout the drawings; no repetition is incorporated in the descriptions. It should be indicated that a noise-cancelling earphone 300 in the embodiment is mostly similar to the noise-cancelling earphone 200 in FIG. 2. Accordingly, some descriptions in the previous embodiment are incorporated in the embodiment, and descriptions concerning the same technical content are omitted. Please refer to the previous embodiment for details concerning the omitted technical content; no repetition is incorporated herein. In the embodiment, the main difference between the noise-cancelling earphone 300 and the noise-cancelling earphone 200 in FIG. 2 is, for example, a speaker 320 is disposed in an eartip 360.

Specifically, in the embodiment, a chamber 314 of the noise-cancelling earphone 300 includes a second accommodating space A2 isolated from a tube 312, and the second microphone 340 is disposed in the second accommodating space A2. In other words, the chamber 314 does not communicate with the tube 312, and the speaker 320 is more close to the first microphone 330. With such configuration, the size of the noise-cancelling earphone 300 is further reduced.

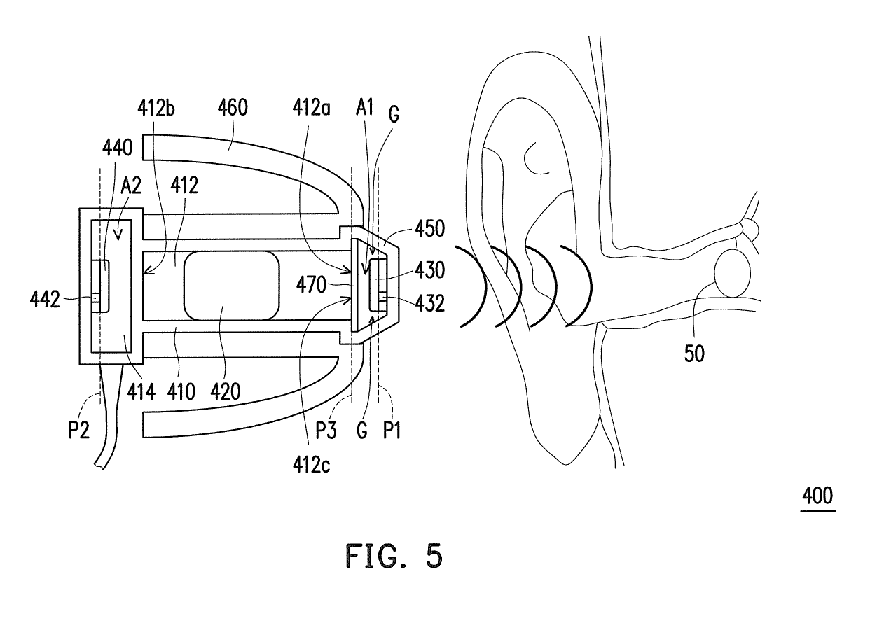

FIG. 5 is a schematic view illustrating a noise-cancelling earphone according to a fourth embodiment of the invention. Referring to FIGS. 4-5, identical or similar numbers refer to identical or similar elements throughout the drawings; no repetition is incorporated in the descriptions. It should be indicated that a noise-cancelling earphone 400 in the embodiment is mostly similar to the noise-cancelling earphone 300 in FIG. 4. Accordingly, some descriptions in the previous embodiment are incorporated in the embodiment, and descriptions concerning the same technical content are omitted. Please refer to the previous embodiment for details concerning the omitted technical content; no repetition is incorporated herein. In the embodiment, the main difference between the noise-cancelling earphone 400 and the noise-cancelling earphone 300 in FIG. 4 is, for example, the noise-cancelling earphone 400 further includes a carrier 450, wherein the carrier 450 is connected with a first end 412a of the tube 412. The carrier 450 has a first accommodating space A1 to accommodate the first microphone 430, and the first accommodating space A1 is disposed between the tube 412 and the user's eardrum 50; the structure and function thereof are similar to the configuration illustrated in FIG. 1, and thus no repetition is incorporated herein.

In summary, in the noise-cancelling earphone described in the embodiments of the invention, the first audio inlet of the first microphone faces toward the user's eardrum to receive noise in the ear canal. The second audio inlet of the second microphone faces toward the outer environment to receive noise from the outer environment. With such configuration, noise can be collected more efficiently, thereby achieving better noise-cancelling effect. In addition, in the noise-cancelling earphone described in the embodiments of the invention, with the combination of circuit carrier and flexible circuit board, the assembling size and weight of electronic product can be reduced, and connection error of circuit can be avoided as well. Moreover, complexity of assembling the noise-cancelling earphone can be simplified, allowing maximum flexibility for component connection and assembling space.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

1. A noise-cancelling earphone for providing an audio source to a user's eardrum, comprising:
a housing comprising a tube and a chamber, the tube comprising a first end and a second end opposite to the first end, the first end of the tube comprising an audio outlet, and the chamber being connected with the second end of the tube;
a speaker disposed in the housing;
a first microphone disposed on the first end of the tube, disposed at the audio outlet, and situated between the tube and user's eardrum, the first microphone comprising a first audio inlet facing toward the user's eardrum; and
a second microphone disposed in the chamber, the second microphone comprising a second audio inlet facing toward an outer environment.

2. The noise-cancelling earphone according to claim 1, wherein the first microphone having a first plane in which the first audio inlet is located and the second microphone having a second plane in which the second audio inlet is located, and the second plane is parallel to the first plane.

3. The noise-cancelling earphone according to claim 2, wherein the first plane of first microphone is located between the second plane of the second microphone and the audio outlet.

4. The noise-cancelling earphone according to claim 2, wherein the audio outlet is located between the first plane of first microphone and the second plane of the second microphone.

5. The noise-cancelling earphone according to claim 1, further comprising a carrier, wherein the carrier is connected with the first end of the tube, the carrier has a first accommodating space to accommodate the first microphone, and the first accommodating space is between the tube and the user's eardrum.

6. The noise-cancelling earphone according to claim 1, wherein the speaker is disposed in the chamber of the housing.

7. The noise-cancelling earphone according to claim 6 further comprising an eartip, wherein the tube is covered by the eartip, and the speaker is disposed outside the eartip.

8. The noise-cancelling earphone according to claim 6, wherein the chamber comprises a plurality of second accommodating spaces isolated from one another, and the speaker and the second microphone are respectively disposed in the second accommodating spaces isolated from one another.

9. The noise-cancelling earphone according to claim 1, wherein the speaker is disposed in the tube of the housing.

10. The noise-cancelling earphone according to claim 9 further comprising an eartip, wherein tube is covered by the eartip, and the speaker is disposed in the eartip.

11. The noise-cancelling earphone according to claim 10, wherein the chamber comprises a second accommodating space isolated from the tube, and the second microphone is disposed in the second accommodating space.

12. The noise-cancelling earphone according to claim 1 further comprising a partitioning mesh, wherein the partitioning mesh is disposed at the audio outlet and the first microphone is disposed on the partitioning mesh.

13. The noise-cancelling earphone according to claim 1, wherein a gap is formed at the audio outlet of the housing and surrounds circumference of the first microphone to allow the sound airflow to pass through.

14. The noise-cancelling earphone according to claim 1 further comprising:
a circuit carrier disposed in the tube to carry the first microphone; and
a flexible circuit board electrically connected with the first microphone, the circuit board and the speaker.

15. The noise-cancelling earphone according to claim 1, wherein the speaker is disposed between the second microphone and the tube.

16. A noise-cancelling earphone for providing an audio source to a user's eardrum, comprising:
a housing comprising a tube and a chamber, the tube comprising a first end and a second end opposite to the first end, the first end of the tube comprising an audio outlet, and the chamber being connected with the second end of the tube;
a speaker disposed in the housing;
a first microphone disposed on the first end of the tube and outside of the audio outlet, the first microphone comprising a first audio inlet facing toward the user's eardrum;
a second microphone disposed in the chamber, the second microphone comprising a second audio inlet facing toward an outer environment; and
a carrier, protruding from the tube to carry the first microphone.
